(19) United States
(12) Patent Application Publication
(10) Pub. No.: US 2025/0251699 A1
(43) Pub. Date: Aug. 7, 2025

(54) CASE DEVICE, TIMEPIECE, AND METHOD FOR MANUFACTURING CASE DEVICE

(71) Applicant: CASIO COMPUTER CO., LTD., Tokyo (JP)

(72) Inventors: Yukio FUNABARA, Tokyo (JP); Yuusuke Awano, Tokyo (JP); Kiwamu Suzuki, Tokyo (JP)

(21) Appl. No.: 19/045,276

(22) Filed: Feb. 4, 2025

(30) Foreign Application Priority Data
Feb. 5, 2024 (JP) 2024-015876

(51) Int. Cl. G04B 37/22

(52) U.S. Cl. CPC G04B 37/225

(57) ABSTRACT

A case device according to an aspect of the present disclosure includes: an inner case; an outer case; a plating film formed on an appearance portion visible from outside on a surface of the outer case; and a cover member, wherein the outer case is made of a second material that is a plating-targeted material on which the plating film is formable, the inner case is made of a first material that is a non-plating-targeted material on which the plating film is less easily formed than the second material, and the inner case is covered with the outer case and the cover member.

### CROSS-REFERENCE TO RELATED APPLICATIONS

This application is based upon and claims the benefit of priority from Japanese Patent Application No. 2024-015876, filed Feb. 5, 2024, the entire contents of which are incorporated herein by reference.

### FIELD

The present invention relates generally to a case device, a timepiece, and a method for manufacturing a case device.

### BACKGROUND

Jpn. Pat. Appln. KOKAI Publication No. 2015-64287 discloses a decorative ring including a translucent frame body made of a non-plating-targeted material on which a plating film is hardly formed, a metal tone forming portion made of a plating-targeted material on which a plating film can be formed, and a plating layer formed on an appearance portion of the metal tone forming portion, the appearance portion being visible from an outside.

### SUMMARY

A case device according to an aspect of the present disclosure comprises:
an inner case;
an outer case;
a plating film formed on an appearance portion visible from outside on a surface of the outer case; and
a cover member, wherein
the outer case is made of a second material that is a plating-targeted material on which the plating film is formable,
the inner case is made of a first material that is a non-plating-targeted material on which the plating film is less easily formed than the second material, and
the inner case is covered with the outer case and the cover member.

### BRIEF DESCRIPTION OF THE DRAWINGS

FIG. 1 is a plan view illustrating a configuration of a timepiece according to a first embodiment.

FIG. 2 is a cross-sectional view illustrating the configuration of the timepiece.

FIG. 3 is a cross-sectional view illustrating a configuration of the timepiece case.

FIG. 4 is a perspective view illustrating a configuration of a case body of the timepiece case as viewed from a surface side.

FIG. 5 is a perspective view illustrating a configuration of a case body of the timepiece case as viewed from a back surface side.

FIG. 6 is a cross-sectional view illustrating a configuration of a timepiece according to a second embodiment.

FIG. 7 is a plan view illustrating a configuration of a case body of the timepiece case.

FIG. 8 is a cross-sectional view illustrating the configuration of the case body.

### DETAILED DESCRIPTION

### First Embodiment

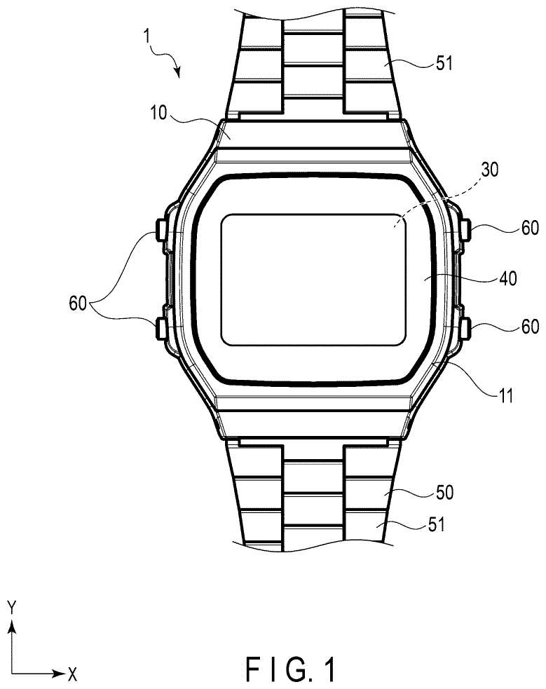

Hereinafter, configurations of a timepiece 1 and a timepiece case 10 that is a case device according to a first embodiment of the present invention will be described with reference to FIGS. 1 to 5. For example, the timepiece 1 will be described assuming that one side in one direction where an outer surface of a windshield member 40 faces is a front side, and the other side in the one direction where a surface of a back lid 12 faces is a back side. For example, the timepiece 1 is worn such that the back-side outer surface faces an arm on which the timepiece is to be worn. In the drawing, X, Y, and Z represent three directions orthogonal to one another. For example, in the present embodiment, the timepiece 1 will be described as an example in which a first direction along a Z axis is a front and back direction of the timepiece 1, an X axis goes along a lateral direction connecting 3:00 and 9:00 of the timepiece 1, and a Y axis goes along a longitudinal direction connecting 6:00 and 12:00 of the timepiece 1. However, the present embodiment is not limited to this example. Note that, in each drawing, the configuration is schematically illustrated by being appropriately enlarged, reduced, or omitted.

As illustrated in FIGS. 1 to 3, the timepiece 1 is, for example, a wristwatch, and includes the timepiece case 10 (case device) constituting an outer shell, a timepiece module 30 provided in the timepiece case 10, and the windshield member 40 (another member) as a cover member that covers a front side of the timepiece module 30. Further, the timepiece 1 also includes a timepiece band 50 having band members 51 connected to two locations on an outer peripheral portion of the timepiece case 10, and a plurality of push buttons 60 disposed on an outer periphery of the timepiece case 10.

The timepiece case 10 includes a case body 11 formed in a circular shape and arranged on an outer peripheral portion of the timepiece module 30, and the back lid 12 (another member) as a cover member disposed on the back side of the timepiece module 30.

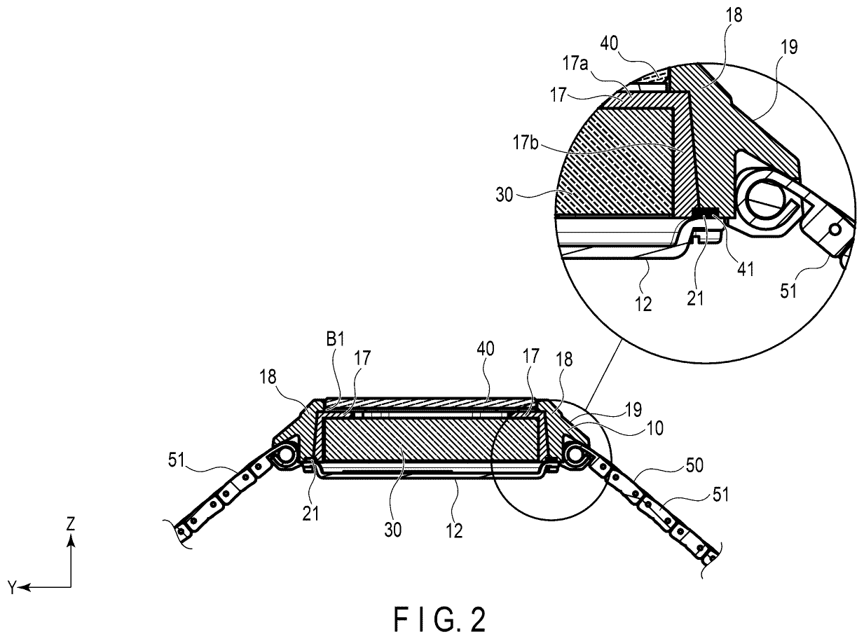

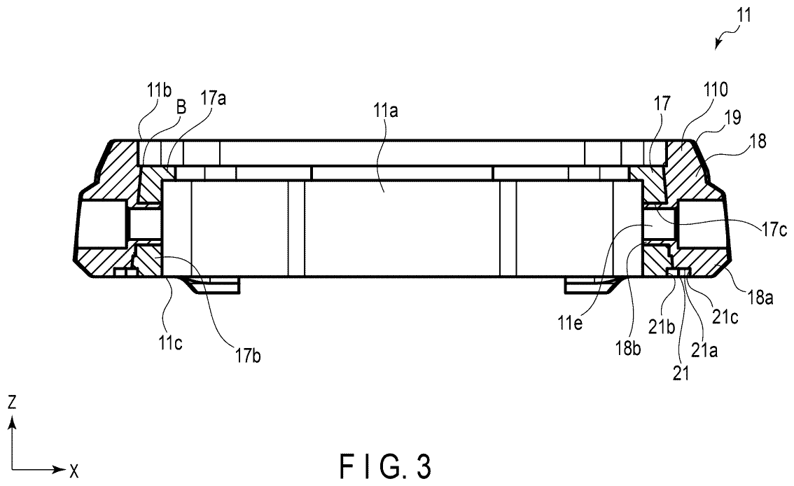

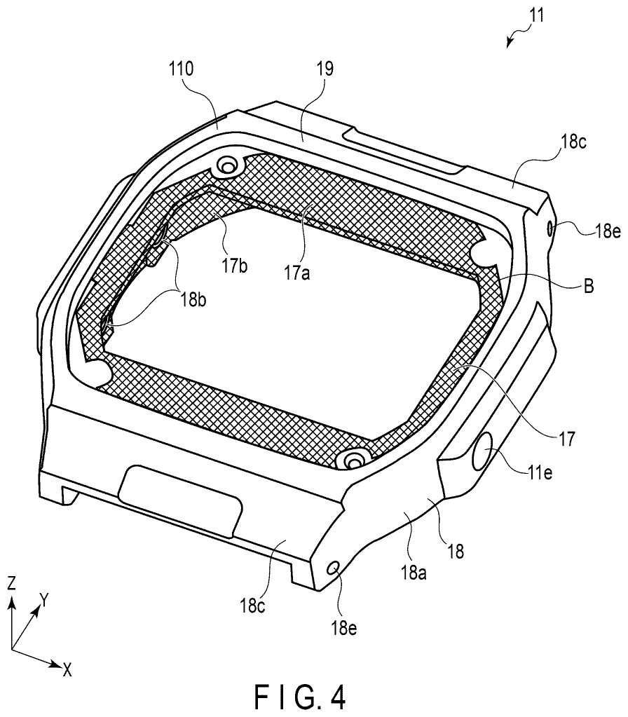

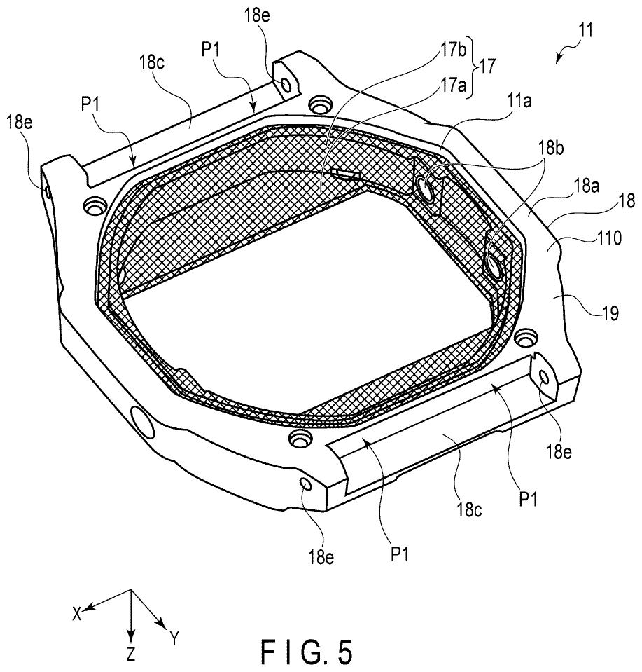

As illustrated in FIGS. 4 and 5, the case body 11 is formed in a cylindrical shape. The case body 11 has a circular accommodation space 11a (accommodation portion) in which the timepiece module 30 is arranged in a center, and has a front opening 11b on the front side that is one side and a back opening 11c on the back side that is the other side in one direction along a center axis of a circle. The timepiece module 30 illustrated in FIGS. 1 and 2 is disposed in the accommodation space 11a formed in the case body 11. The front opening 11b of the case body 11 is covered with the windshield member 40 illustrated in FIGS. 1 and 2. The back opening 11c of the case body 11 is covered with the back lid 12 illustrated in FIG. 2. As illustrated in FIGS. 2 and 3, a ring groove 21 is formed in a back surface-side edge portion of the case body 11, and an O-ring 41 (waterproof member) for waterproofing, which makes a space between the back lid 12 and the ring groove 21 airtight, is attached to the ring groove 21.

The ring groove 21 is formed over an entire periphery in a peripheral direction. The ring groove 21 is a recessed portion formed on a back-side facing surface of the case body 11, which faces the back lid 12 and having a predetermined width along a peripheral edge of the back lid 12 retracted to the front side. As illustrated in FIG. 3, the ring groove 21 includes a bottom surface portion 21a retracted to the front side with respect to the back-side surface of the case body 11, a side wall 21b on an inner peripheral side, and a side wall 21c on an outer peripheral side.

Further, the case body 11 includes protruding portions 18c (band attachment portions) having lug holes 18e to which the timepiece band 50 is attached at two locations facing each other in the outer peripheral portion, for example, at positions of 6:00 and 12:00, respectively.

The case body 11 is formed by two-color molding, and includes an inner case portion 17 as a first case portion formed by primary molding with a first material, an outer case portion 18 as a second case portion formed by secondary molding with a second material, and a plating film 19 formed on a surface of the outer case portion 18.

For example, the inner case portion 17 is a portion that has a surface portion covered with the cover members such as the windshield member 40 and the back lid 12 in a product state, and becomes a non-appearance portion that cannot be visually recognized from the outside, and is made of a first resin material (first material). As the first resin material, for example, a non-plating material (non-plating-targeted material) on which a plating film is less easily formed than the second resin material is used for a target plating material. For example, the first resin material is made of polycarbonate (PC). Note that, in the present embodiment, as will be described below, the plating film 19 includes a base plating layer (first plating layer) by electroless plating and a main plating layer (second plating layer) by electrolytic plating. For this reason, as the first resin material, a material on which the base plating layer that is a target plating material is not formed is used, for example.

As an example, in FIGS. 4 and 5, the inner case portion 17 is illustrated by hatching. The inner case portion 17 has, for example, a front wall portion 17a that is a portion on the front side of the module 30 and on the outer peripheral side, and a frame-shaped inner wall portion 17b that is a peripheral wall portion extending from an outer peripheral edge of the front wall portion 17a to the back side and disposed to face the outer periphery of the module 30.

The outer case portion 18 is formed by secondary molding with the second resin material (second material). The second resin material is a plating-targeted material that can be plated with a plating material constituting a target plating film, and is, for example, a material containing an ABS resin. As an example, in the present embodiment, the outer case portion 18 is made of the ABS resin. The outer case portion 18 includes a frame-shaped outer wall portion 18a disposed on the outer peripheral side of the front wall portion 17a and the inner wall portion 17b of the inner case portion 17, a cylindrical portion 18b as an extending portion protruding toward the inner peripheral side from the outer wall portion 18a, and a protruding portion 18c protruding toward the outer peripheral side from the outer wall portion 18a. For example, the outer case portion 18 is mainly configured as a portion that becomes the appearance portion visible from the outside in the product state. In the case of the present embodiment, the entire appearance portion is constituted by the outer case portion 18. Meanwhile, a part of the outer case portion 18 may be provided in the non-appearance portion. That is, a part of the outer case portion 18 may be covered with another member.

That is, for example, the cylindrical portion 18b that is an extending portion protrudes inward from a predetermined location of the outer wall portion 18a constituting the outer peripheral portion of the case body 11 in the present embodiment through a tubular port portion 17c (see FIG. 3) that is a through hole formed in the inner wall portion of the inner case portion 17, and a distal end portion thereof is formed to reach the inner surface of the case body 11. An outer peripheral surface of the cylindrical portion 18b is covered with the inner case portion 17, and a distal end surface thereof constitutes a non-appearance portion disposed to face the module 30. In other words, the outer case portion 18 may constitute a part of the non-appearance portion. In the present embodiment, the cylindrical portion 18b is formed at a portion where the push button 60 is disposed, and constitutes a hole for a button through which a part of the push button 60 passes. In addition, the outer case portion 18 may constitute, for example, a portion near a boundary between the appearance portion and the non-appearance portion, of the non-appearance portion.

The protruding portions 18c are formed, for example, at the 6:00 position and the 12:00 position of the timepiece. The protruding portion 18c constitutes the band attachment portion to which the timepiece band 50 is attached. The lug hole 18e, which is a hole through which a fastening member or the like connecting the band member 51 passes, is formed in the protruding portion 18c.

The plating film 19 is a film formed on a surface layer portion of the outer case portion 18. For example, the plating film 19 is made of gold (Au) or the like. For example, the plating film 19 may have a multilayer structure including the base plating layer formed by electroless plating and the main plating layer formed by electroplating. As an example, the plating film 19 includes the base plating layer containing nickel, copper, or the like by electroless plating, and the main plating layer containing gold, chromium, palladium, or the like.

The plating film 19 is mainly formed on the surface of the appearance portion. In the case of the present embodiment, the entire appearance portion is covered with the plating film 19. As an example, in the present embodiment, the plating film 19 is also formed on the distal end surface not covered with the inner case portion 17, of the cylindrical portion 18b that is the non-appearance portion. In addition, the plating film 19 may be formed, for example, at a portion near a boundary between the appearance portion and the non-appearance portion, of the non-appearance portion. Note that the position of the boundary between the non-appearance portion and the appearance portion and the position of a boundary B between the inner case portion 17 and the outer case portion 18 do not necessarily coincide with each other. For example, the boundary B is disposed at the same position as the boundary between the non-appearance portion and the appearance portion, or in a region inside the boundary, that is, on a non-appearance portion side.

The back lid 12 is a plate-shaped member that covers the back side of the case body 11 and the timepiece module 30. For example, the back lid 12 is fastened to an edge portion of the back opening 11c of the case body 11 by a fastening member such as a screw on an outer peripheral edge side thereof. The back lid 12 is a cover member that covers the surface of the inner case portion 17 of the case body 11. As an example, the position of the outer peripheral edge of the back lid 12 is disposed to face the outer peripheral portion of the ring groove 21 in which the O-ring 41 is disposed. That is, the back lid 12 is disposed on the back-side surface of the case body 11 at a position overlapping an outer edge of the inner case portion 17 or outside the outer edge of the inner case portion 17. The outer edge of the back lid 12 may partially or entirely face the outer case portion 18. In other words, on the back surface side of the case body 11, the boundary between the non-appearance portion covered with the back lid 12 and the appearance portion not covered with the back lid 12 is disposed at the same position as or outside the position of the boundary between the inner case portion 17 and the outer case portion 18. Note that the surface of the inner case portion 17 of the case body 11 is not necessarily covered only with the back lid 12. That is, the back lid 12 may be a cover member that covers at least a part of the surface of the inner case portion 17 of the case body 11. For example, the surface of the inner case portion 17 of the case body 11 may be covered with the back lid 12 and another member.

The timepiece module 30 includes various components necessary for a timepiece function, such as a display unit that displays information such as time and date, a movement that operates the display unit, a circuit board on which electronic components such as an IC and an antenna are mounted, and a battery. For example, the display unit may be a digital display unit having a liquid crystal display panel or the like having a digital display function, or may be an analog display unit having a dial, a pointer, and the like. In addition, a plurality of display units may be provided.

The windshield member 40 is a transparent member made of, for example, inorganic glass such as SiO2 glass. For example, the windshield member 40 is a transparent plate-shaped timepiece glass, is disposed on the front side of the timepiece module 30, and covers the timepiece module 30. For example, the windshield member 40 is supported by an inner peripheral edge of the front opening 11b of case body 11. Packing is interposed between the outer periphery of the windshield member 40 and the inner peripheral edge of the case body 11. Note that the windshield member 40 has an opaque portion such as a printed layer or a deposited portion on a part of a back surface. For example, the windshield member 40 has an opaque portion in a region on the outer peripheral side with respect to a display region of the dial. Therefore, the region on the outer peripheral side of the windshield member 40 on the upper surface of the inner case portion 17 is not covered with the outer case portion 18, but the inner case portion 17 cannot be visually recognized from the appearance. Note that the windshield member 40 may not include the opaque portion. In this case, the region on the outer peripheral side of the windshield member 40 and the upper surface of the inner case portion 17 are bonded with a double-sided adhesive tape of black or the like. Thus, the windshield member 40 has a colored region. The windshield member 40 is a cover member that covers at least a part of the surface of the inner case portion 17 of the case body 11. As an example, the position of the outer peripheral edge of the windshield member 40 is disposed on the front-side surface of the case body 11 at a position overlapping the outer edge of the inner case portion 17 or outside the outer edge of the inner case portion 17. That is, at least a part of the outer edge of the windshield member 40 may face the outer case portion 18. In other words, in the present embodiment, the boundary between the non-appearance portion covered with the windshield member 40 and the appearance portion not covered with the windshield member 40 is disposed at the same position as the boundary B between the inner case portion 17 and the outer case portion 18 or outside the position of the boundary B on the front side of the case body 11.

The timepiece band 50 includes a pair of the band members 51 and coupling mechanisms such as buckles connected to two opposing locations on the outer periphery of the timepiece case 10. The push button 60 is provided on the outer peripheral portion of the case, and performs, for example, mode switching, time correction, and the like of the timepiece module 30 by a pushing operation of an operator.

In the timepiece 1 configured as described above, in the surface of the case body 11, an inner-side region of a portion where the windshield member 40 overlaps is constituted by the inner case portion 17, as illustrated in FIG. 3, for example. Meanwhile, a portion on the outer peripheral side of the portion where the windshield member 40 overlaps is entirely constituted by the outer case portion 18. Note that a partial region overlapping the outer edge portion of the windshield member 40 is constituted by the outer case portion 18.

Further, as illustrated in FIG. 4, an inner peripheral-side portion of the case body 11, which is also an inner-side region covered with the back lid 12, is constituted by the inner case portion 17. Further, peripheral edge portions of button holes 11e provided in two locations of an inner wall surface are constituted by the outer case portion 18. Meanwhile, a portion on the outer peripheral side of the portion where the back lid 12 overlaps is entirely constituted by the outer case portion 18. That is, the entire appearance portion, which is at least a portion viewed from the outside, is constituted by the outer case portion 18.

Further, the bottom surface portion 21a of the ring groove 21 formed in the case body 11 is disposed over the boundary B between the inner case portion 17 and the outer case portion 18 in a groove width direction orthogonal to the peripheral direction and the front and back direction. That is, the inner peripheral-side side wall 21b inside the ring groove 21 is arranged in the inner case portion 17, and the outer peripheral-side side wall 21c is formed in the outer case portion 18.

A method for manufacturing the case body 11 according to the present embodiment includes a primary molding process (first molding process) of forming the inner case portion 17 with the first resin material, a secondary molding process (second molding process) of forming the outer case portion 18 with the second resin material, and a plating process of performing electroplating treatment.

In the primary molding process, the first resin material that is a non-plating resin such as polycarbonate is molded into a predetermined shape. Specifically, the first resin material is poured into a mold for primary molding and cured to form the frame-shaped inner case portion 17 as a primary molded article. In the secondary molding process, the second resin material that is a plating resin on which a plating film such as an ABS resin can be formed is molded into a predetermined shape. In a state where the frame-shaped inner case portion 17 as the primary molded article is set in a mold for secondary molding using the mold for secondary molding, the second resin material is supplied to the mold for secondary molding and cured to constitute a tubular base material 110 (see FIG. 5) in which the inner case portion 17 and the outer case portion 18 are integrated.

Subsequently, the plating process of forming a plating film on a surface of the tubular base material 110 in which the inner case portion 17 and the outer case portion 18 are integrated is performed. First, as a pre-process, the base material 110 is hooked and held on a jig, and a palladium catalyst is adsorbed in a first material portion on the surface of the outer case portion 18 by etching treatment and then catalyst treatment. A metal film as a base is formed using the palladium catalyst as a core by electroless plating treatment, and then the electroplating treatment is performed as a main process.

Next, rack plating is performed as electroplating treatment. For example, the base material 110 and metal to be deposited are disposed in a solution containing metal ions. At this time, energizing arms as a jig are pressed inward to hold the base material 110 at a plurality of outer peripheral-side locations of the base material 110, for example, at four holding points P1. Then, a negative electrode is connected to the metal for film formation, and a positive electrode is connected to the base material 110, and a direct current is caused to flow. If a reduction reaction occurs in the solution, the metal is deposited on the outer surface portion of the outer case portion 18 of the base material 110 where the base plating is formed, and the plating film 19 is formed. In the plating treatment, thickness can be controlled by magnitude of the current and an energization time. For example, the plating film 19 has the thickness of about 30 μm.

According to the present disclosure, it is possible to provide a case device, a timepiece, and a method for manufacturing a case device that can improve an appearance property.

According to the timepiece case 10 and the timepiece 1 configured as described above, it is possible to reduce thickness deviation of the secondary-molded portion by forming the case body 11 by two-color molding. Therefore, it is possible to reduce sink marks and to shorten a molding cycle. In particular, in a case where the surface is plated, irregularities such as sink marks easily affect the appearance, but since the thickness of each of the molded portions 17 and 18 is suppressed, the irregularities such as sink marks due to shrinkage can be reduced.

In the timepiece case 10 and the timepiece 1 according to the above embodiment, it is possible to reduce a plating area and to reduce an amount of noble metal used for plating by forming a part of the case body 11 with the first material on which plating is less easily formed. In addition, since the portion where plating is formed by two-color molding can be defined, it is not necessary to perform masking on a portion not requiring plating or to melt the plating film on the unnecessary portion, and it is possible to easily reduce the plating area even in a complicated shape. In addition, for example, in a method of masking a region where plating is not formed in advance and melting a plating film of an unnecessary portion with a strong acid or the like, it is difficult to select a masking agent that is not attacked by etching in pre-plating treatment, but according to the above embodiment, it is possible to easily form plating only on a necessary portion.

### Second Embodiment

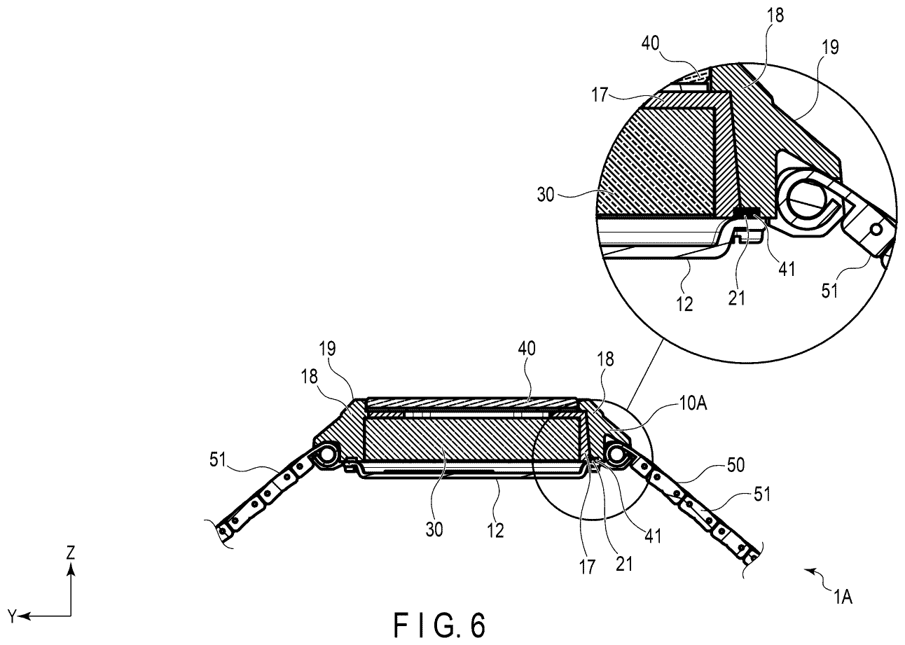

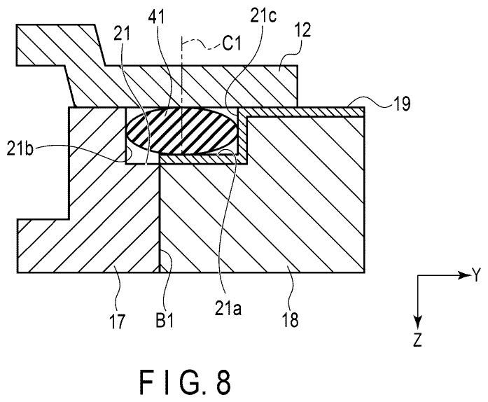

A timepiece 1 and a timepiece case 10 according to a second embodiment will be described below with reference to FIGS. 6 to 8. For example, in the present embodiment, a part of an inner wall that serves as an electrical contact portion of a case body 11A is constituted by an outer case portion 18. The other configurations are similar to those of the above-described first embodiment. The case body 11A according to the present embodiment has a similar configuration to the case body 11 described in the first embodiment.

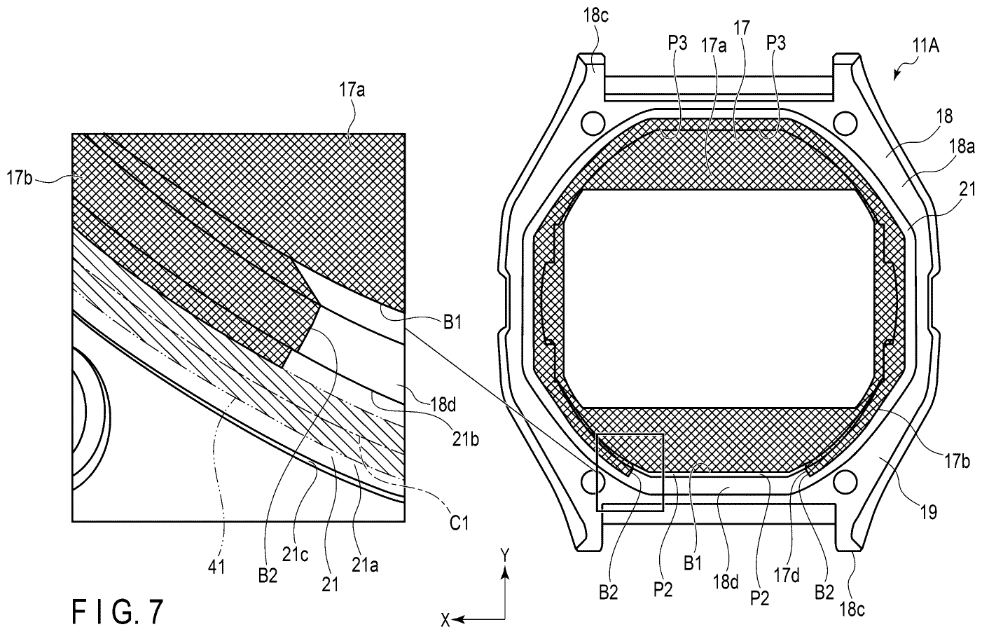

FIG. 7 illustrates an inner case portion 17 in a shaded manner. The inner case portion 17 has, for example, a front wall portion 17a disposed to face a front side of a module 30 and an inner wall portion 17b disposed to face an outer periphery of the module 30. In the present embodiment, the inner wall portion 17b is partially cut in a peripheral direction. That is, the inner wall portion 17b is configured in a frame shape having an opening 17d in a part on a 6:00 side of the timepiece.

The outer case portion 18 includes a frame-shaped outer wall portion 18a disposed on an outer peripheral side of the front wall portion 17a and the inner wall portion 17b of the inner case portion 17, and a widened portion 18d that is a protruding portion (extending portion) partially bulging inward from the outer wall portion 18a. For example, the outer case portion 18 is mainly constituted as a portion that becomes an appearance portion in a product state. In the case of the present embodiment, the entire appearance portion is constituted by the outer case portion 18. For example, a part of the outer case portion 18 may be provided in a non-appearance portion. In other words, the outer case portion 18 may constitute a part of the non-appearance portion.

In the present embodiment, the outer case portion 18 has the widened portion 18d having an electrical contact portion. The widened portion 18d is a holding portion that is held in a case where a plating film 19 is formed by, for example, electroplating, and is formed in a region including the electrical contact portion. That is, the outer case portion 18 constitutes an electrical contact. For example, in the present embodiment, the widened portion 18d is a portion formed such that a part of the outer wall portion 18a protrudes toward an inner peripheral side, and constitutes a part of the case body 11 in the peripheral direction. Note that the outer case portion 18 may constitute, for example, a portion near a boundary between an appearance portion and a non-appearance portion, of the non-appearance portion. As an example, in the present embodiment, the plating film 19 is also formed on the widened portion 18d serving as the electrical contact portion which is the non-appearance portion. In addition, the plating film 19 may be formed, for example, at a portion near the boundary between the appearance portion and the non-appearance portion, of the non-appearance portion. For example, thickness of the plating film 19 is about 30 μm.

In the present embodiment, a ring groove 21 in which an O-ring 41 is disposed is formed in a back surface-side edge portion of the case body 11, and the O-ring 41 for waterproofing, which makes a space between a back lid 12 and the ring groove 21 airtight, is attached to the ring groove 21. For example, the ring groove 21 is formed over an entire periphery in a peripheral direction. The ring groove 21 is a recessed portion retracted to the front side and formed on a back-side facing surface of the case body 11, which faces the back lid 12. The ring groove 21 includes a bottom surface portion 21a retracted to the front side from a back-side surface of the case body 11, a side wall 21b on an inner peripheral side, and a side wall 21c on an outer peripheral side. The bottom surface portion 21a of the ring groove 21 is disposed over a boundary B1 between the inner case portion 17 and the outer case portion 18 in a width direction of the ring groove 21. That is, the inner peripheral-side side wall 21b inside the ring groove 21 is arranged in the inner case portion 17, and the outer peripheral-side side wall 21c is formed in the outer case portion 18.

Here, in the present embodiment, a center C1 of the ring groove 21 in the width direction is disposed at a position of the outer case portion 18. That is, the boundary B1 between the outer case portion 18 and the inner case portion 17 in the width direction of the ring groove 21 is disposed on an inner peripheral side with respect to the center C1 of the ring groove 21 in the width direction. Therefore, a center position of the O-ring 41 in the width direction of the ring groove 21 is disposed at a position facing the outer case portion 18.

For example, since the plating film 19 is formed on the outer case portion 18 of the bottom surface portion 21a of the ring groove 21, a step in which the outer case portion 18 is higher than the inner case portion 17 is generated at the boundaries B1 and B2 in the width direction and the peripheral direction of the ring groove 21. However, by disposing a center position of a cross section of the O-ring 41 on the outer case portion 18 side so that the center position of the cross section of the O-ring 41 does not come into contact with the step, it is possible to suppress an airtight defect. As an example, the position of the boundary B1 is set such that a proportion of the first molded portion 17 in the bottom surface portion 21a of the ring groove 21 is ⅓ or less in the width direction of the ring groove 21. Therefore, the boundary B2 in the peripheral direction between the outer case portion 18 and the inner case portion 17 is formed in a direction along the outer periphery, and a contact portion (portion having a maximum thickness) contributing to airtightness near the center of the O-ring 41 passes over the outer case portion 18 without crossing the boundary B2 in the peripheral direction.

FIG. 6 illustrates an airtight part of the case body 11 and the back lid 12 in an enlarged manner. To secure a minimum wall thickness of the inner case portion 17 of the case body 11, there are the boundaries B1 and B2 between the inner case portion 17 and the outer case portion 18 in the bottom surface portion 21a serving as an airtight surface of the ring groove 21 of the case body 11, and the boundaries are kept within a range not applied to the central position serving as a compressed portion of the O-ring 41, whereby the airtightness is maintained.

In the present embodiment, the electrical contact is provided in an internal region that is not exposed after the back lid 12 and a windshield member 40 are assembled. For example, rack portions P2 and P3 that are portions held by jigs in rack plating are set on an inner surface side of the case body 11, and the two rack portions P2 on one side portion of the rack portions are formed in the outer case portion 18 made of a second resin material, so that the rack portions function as holding portions and the electrical contacts of plating. The two rack portions P3 on the other side portion are in the inner case portion 17 made of a first resin material.

In the present embodiment, during electroplating treatment, energizing arms are pressed against the four rack portions P2 and P3 on the inner peripheral side of a base material 110, and pressure is applied from inside to outside to hold the rack portions P2 and P3. Here, the rack portions P2, which are the two holding portions on at least one side, serve as the electrical contacts by being constituted by the widened portion 18d, which is a part of the outer case portion 18.

Also in the present embodiment, effects similar to those of the first embodiment are obtained. In addition, according to the present embodiment, since the electrical contacts can be secured inside, it is possible to prevent an appearance defective portion due to uneven plating film thickness from exposing to an appearance surface and deterioration of corrosion resistance. Note that, in the second embodiment, since the plating electrical contacts are easily set on the inner surface, the center position of the cross section of the O-ring 41 can be configured to be the outer case portion 18 made of a plating resin. A plating film of Au or the like is formed on the outer case portion 18, of the bottom surface portion 21a of the ring groove 21, so that the position of the surface is high. However, it is possible to suppress the airtight defect by disposing a center portion of the O-ring 41, which is a pressurizing portion of the O-ring 41, so as not to overlap the step of the boundaries B1 and B2.

Note that the above-described embodiment is merely an example, and does not limit the scope of the invention. For example, in the first embodiment, an example has been described in which the outer peripheral surface of the base material 110 is pressed from the outside at four points to hold the base material 110 during the electroplating treatment, but the present invention is not limited thereto. For example, it is also possible to use the cylindrical portion 18b as the electrical contact by hooking and holding the energizing arm on the cylindrical portion 18b.

In addition, the plating-targeted material and the non-plating-targeted material are not limited to the above examples, and can be appropriately changed. For example, it can be appropriately selected according to the material of the plating film to be formed or the type of treatment. Further, in the above embodiment, an example has been described in which the entire external appearance portion visible from the outside is the outer case portion 18, and the plating film 19 is formed over the entire external appearance portion, but the present invention is not limited thereto. For example, there may be a portion where the plating film 19 is not formed on a part of the appearance portion visible from the outside.

Further, the positions of the ring groove 21 and the O-ring 41 are not limited to the above positions. For example, in the second embodiment, an example has been described in which the ring groove 21 is formed over the inner case portion 17 and the outer case portion 18 in the width direction, and the O-ring 41 is disposed at the boundary. However, for example, the ring groove 21 and the O-ring 41 may be formed in the region of the outer case portion 18. For example, in a case where the electrical contacts during plating are set to positions other than the inner surface and the widened portion 18d is not formed, the inner case portion 17 is formed over the entire periphery, and thus the boundary B2 and the step in the peripheral direction do not occur. Therefore, the center position of the O-ring 41 may be disposed on either side of the outer case portion 18 or the inner case portion 17.

For example, in the above embodiment, the windshield member 40 and the back lid 12 are exemplified as examples of the cover member, but the cover member is not limited thereto, and may be a bezel or other members. In addition, the procedure of the primary molding and the secondary molding may be reversed. Further, in the above embodiment, the timepiece case 10 has been exemplified as an example of the device, but the present invention is not limited thereto. For example, the present invention can be applied to various devices not having a time function.

Although some embodiments of the present invention have been described, the specific configuration, structure, positional relationship, and the like described in the above embodiments can be appropriately changed without departing from the gist of the present invention. The scope of the present invention is included in the invention described in the claims and the equivalent scope thereof.

What is claimed is:

1. A case device comprising:
an inner case;
an outer case;
a plating film formed on an appearance portion visible from outside on a surface of the outer case; and
a cover member, wherein
the outer case is made of a second material that is a plating-targeted material on which the plating film is formable,
the inner case is made of a first material that is a non-plating-targeted material on which the plating film is less easily formed than the second material, and
the inner case is covered with the outer case and the cover member.

2. The case device according to claim 1, wherein
the plating film includes a first plating layer and a second plating layer formed on a portion where the first plating layer is formed, and
the first material is a material on which the first plating layer is not formed.

3. The case device according to claim 1, wherein the second material is a material containing an ABS resin.

4. The case device according to claim 1, wherein the first material is polycarbonate.

5. The case device according to claim 1, wherein
the case device is formed in a tubular shape, and
the outer case includes an outer wall portion disposed on an outer peripheral side of the inner case, and an extending portion connected to the outer wall portion and extending to an inner peripheral side.

6. The case device according to claim 1, further comprising
a waterproof member, wherein
a groove is formed in a boundary between the inner case and the outer case, the groove being continuously disposed over both the outer case and the inner case, and
a portion of the waterproof member, the portion having a maximum thickness, is disposed above the outer case in a state where the waterproof member is in the groove.

7. The case device according to claim 1, wherein a part of the outer case is covered with the cover member.

8. A timepiece comprising:
the case device according to claim 1; and
a timepiece module disposed in an accommodation portion formed inside the case device, wherein
the cover member is at least one of a windshield member covering one side of the timepiece module and having a colored region, or a back lid covering an other side of the timepiece module.

9. A method for manufacturing a case device including an inner case and an outer case, the method comprising
forming a plating film on an appearance portion visible from an outside on a surface of the outer case by electroplating treatment, wherein
the outer case is made of a second material that is a plating-targeted material on which the plating film is formable, and
the inner case is made of a first material that is a non-plating-targeted material on which the plating film is less easily formed than the second material.

10. The method for manufacturing a case device according to claim 9, the method comprising:
before the forming a plating film,
forming the inner case with the first material; and
forming the outer case with the second material.

11. The method for manufacturing a case device according to claim 9, wherein
the plating film includes a first plating layer and a second plating layer, and
the method comprising:
forming the first plating layer on an appearance portion visible from an outside on a surface of the outer case by electroless plating treatment before the electroplating treatment; and
forming a second plating layer on a portion where the first plating layer is formed by the electroplating treatment.

12. The method for manufacturing a case device according to claim 9, wherein
the plating film includes a first plating layer and a second plating layer formed on a portion where the first plating layer is formed, and
the first material is a material on which the first plating layer is not formed.

13. The method for manufacturing a case device according to claim 9, wherein the second material is a material containing an ABS resin.

14. The method for manufacturing a case device according to claim 9, wherein the first material is polycarbonate.

15. The method for manufacturing a case device according to claim 9, wherein
the inner case includes an inner wall portion disposed on an inner peripheral side of the outer case,
the outer case includes an outer wall portion disposed on an outer peripheral side of the inner case and an extending portion extending from the outer wall portion to the inner peripheral side of the outer case, and
at least a part of the extending portion constitutes an electrical contact in the electroplating treatment.
